(19) United States
(12) Patent Application Publication
(10) Pub. No.: US 2026/0181577 A1
(43) Pub. Date: Jun. 25, 2026

(54) METHODS FOR AI/ML ASSISTED SATELLITE BASED POSITIONING

(71) Applicant: InterDigital Patent Holdings, Inc., Wilmington, DE (US)

(72) Inventors: Fumihiro Hasegawa, Westmount (CA); Yugeswar Deenoo Narayanan Thangaraj, Chalfont, PA (US); Dylan Watts, Montreal (CA); Moon IL Lee, Melville, NY (US); Patrick Tooher, Montreal (CA)

(73) Assignee: InterDigital Patent Holdings, Inc., Wilmington, DE (US)

(21) Appl. No.: 18/989,140

(22) Filed: Dec. 20, 2024

(51) Int. Cl. H04W 64/00; H04L 5/00; H04W 84/06

(52) U.S. Cl. CPC H04W 64/00; H04L 5/0051; H04W 84/06

(57) ABSTRACT

The operation of a wireless transmit/receive unit (WTRU) is defined by a configured processor or a method of operation to determine a positioning accuracy requirement based on one or more triggering conditions. The processor sends a request for a positioning reference signal (PRS) configuration and receives one or more PRS transmissions. The WTRU may then receive a request from a network to report a validity area, such as for artificial intelligence or machine learning (AI/ML) positioning. The validity area may be associated with a non-terrestrial network. The determination may be based on the positioning accuracy requirement and a plurality of PRS transmissions. The WTRU may further send a report to the network, wherein the report comprises an indication of at least the validity area for AI/ML positioning.

### BACKGROUND

Artificial intelligence or machine learning (AI/ML) based positioning may use fingerprints in measurements. Typically, a WTRU makes measurements on positioning reference signals (PRSs) transmitted from satellites. Based on these measurements, the WTRU trains the AI/ML model(s) at the WTRU. For AI/ML based positioning to be effective, consistency needs to be achieved between training and inference phase. One PRS beam from a satellite (for example, a geo stationary satellite) may cover a very large area. Hence, conventional positioning techniques (e.g., Global Navigation Satellite System (GNSS), or terrestrial positioning) may not be effective in non-line of sight (NLOS) conditions.

### SUMMARY

The operation of a wireless transmit/receive unit (WTRU) is defined by a processor configured to first determine a positioning accuracy requirement based on one or more triggering conditions. The processor sends a request for a positioning reference signal (PRS) configuration and receives one or more PRS transmissions. The WTRU may then receive a request from the network to report a validity area, such as for artificial intelligence or machine learning (AI/ML) positioning. The validity area is contemplated to be associated with a non-terrestrial network (NTN). The determination by the WTRU of the validity area for AI/ML positioning may be based on the positioning accuracy requirement and the one or more PRS transmissions. The WTRU may send a report to the network, wherein the report comprises an indication of at least the validity area for AI/ML positioning.

In embodiments of the WTRU, the positioning accuracy requirement may include a range of accuracy of the WTRU. The triggering condition may include one or more of a need for timing compensation for an NTN, an emergency call, and a network verification request. The network requesting the validity area may be a non-terrestrial based network. In embodiments, the WTRU report may include an indication of one or more satellites used by the WTRU to determine the validity area, a location of the WTRU, the positioning accuracy requirement, or a line of sight (LOS) condition with one or more satellites.

In embodiments, the WTRU may request assistance information for WTRU-based positioning. For example, the processor may be configured to receive the assistance information from another network. In addition, the assistance information may include one or both of an indication of an atmospheric condition or an ephemeris. The WTRU processor may further be configured to determine the validity area for AI/ML positioning based on a location of the WTRU, for example, wherein the location is based on a terrestrial cell identifier (ID). The WTRU processor may be further configured to determine the validity area for AI/ML positioning based on an environmental condition, such as an atmospheric condition. In addition, or as an alternative, the determination of the validity area for AI/ML positioning may be based on a line-of-sight (LOS) condition associated with one or more satellites. In embodiments, the request for PRS configurations may indicate a position accuracy requirement for the WTRU. In embodiments, the one or more PRS configurations contains coverage information for the PRS, including the number of states the PRS beam is covering.

### BRIEF DESCRIPTION OF THE DRAWINGS

FIG. 1A is a system diagram illustrating an example of a terrestrial-based communication system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of the use of an AI/ML model to estimate WTRU location.

FIG. 3 shows an example of a plurality of interfaces that may be present in a non-terrestrial network.

FIG. 4 shows an example of terrestrial communication and the need for consistency preservation within an area, across PRSs.

FIG. 5 shows a further example of the need for consistency preservation within one PRS in an NTN.

FIG. 6 shows an example of defining a validity area for satellite-based positioning within an NTN.

FIG. 7 shows an example of a WTRU receiving PSRs from more than one satellite within an NTN.

FIG. 8 shows an embodiment of the signaling between a WTRU and an LMF within an NTN.

### DETAILED DESCRIPTION

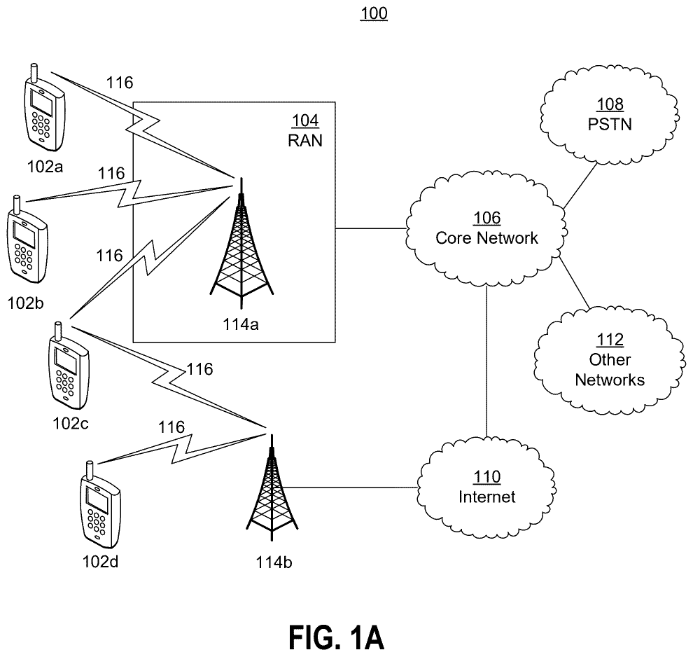

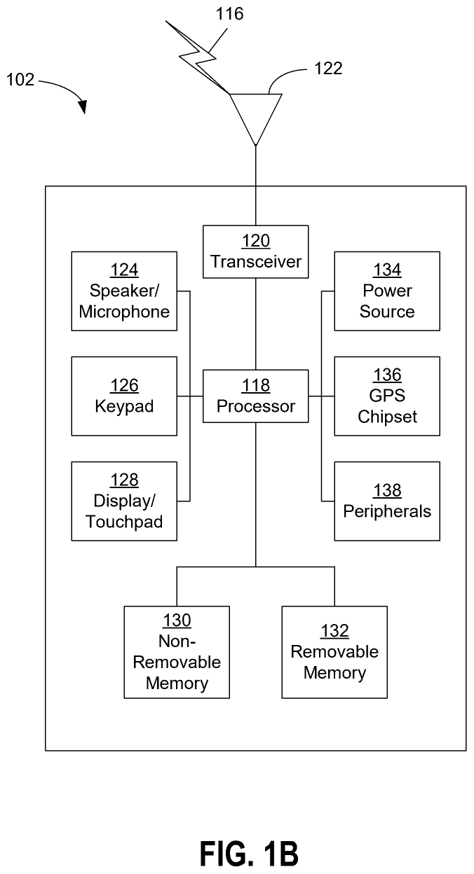

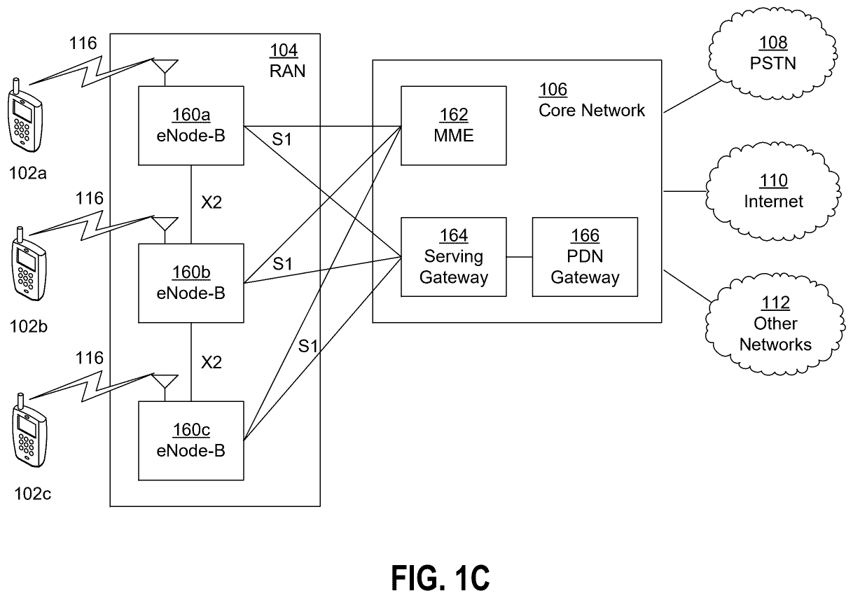

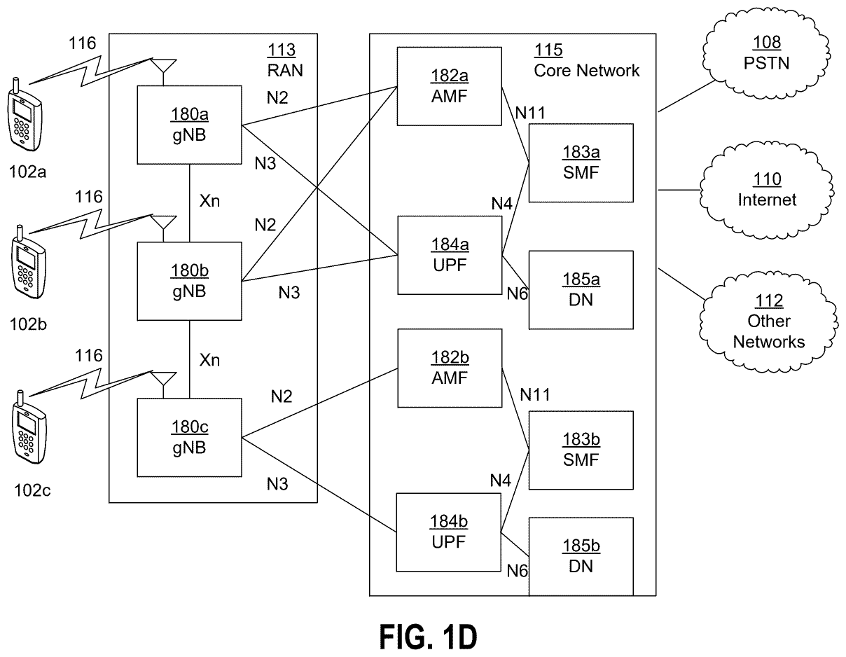

FIG. 1A is a diagram illustrating an example communications system 100 in which one or more disclosed embodiments may be implemented. The communication system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description or drawing related hereto that makes reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize one or more transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together into an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

General WTRU behavior may include the WTRU sending a request to the network for configuration (e.g., Downlink Reference Signal (DL-RS) configurations, Uplink Reference Signal (UL-RS) configurations) in Physical Uplink Shared Channel (PUSCH), Physical Uplink Control Channel (PUCCH), Uplink Control Information (UCI), Medium Access Control-Control Element (MAC-CE), Radio Resource Control (RRC) or LTE Positioning Protocol (LPP) message. The request from the WTRU may include configurations of a measurement gap, DL-RS processing window or window for transmission of UL-RS.

The WTRU may send an acknowledgement message in PUSCH or PUCCH for the grant received from the network.

More than one conditions/criteria may be used in a combination. The WTRU may be configured with more than one condition and associated WTRU behavior and the WTRU may determine which behavior the WTRU shall use based on the applicable condition.

The WTRU may measure DL-RS inside or outside of active Bandwidth Part (BWP). The WTRU may transmit UL-RS inside or outside of active BWP.

The WTRU may be preconfigured with parameters (e.g., measurement gaps, DL-RS processing windows, DL-RS configurations, UL-RS configurations) via a semi-static message (e.g., LPP, RRC).

The WTRU may report measurements or configuration parameters in a semi-static message (e.g., LPP, RRC) or dynamic message (e.g., UCI, MAC-CE).

Any actions the WTRU determines to take may be configured by the network. For example, the WTRU may be configured with a rule and according to the rule, the WTRU may determine to take an associated action.

In addition to the measurements made on DL-RS, the WTRU may include at least one of the following cell-related measurements: (a) Synchronization Signal Block (SSB) Reference Signal Received Power (RSRP) (SSB RSRP) from the serving cell with corresponding cell ID; (b) SSB RSRP from the neighboring cell(s) with corresponding cell ID(s); (c) RSRP of Channel State Information Reference Signal (CSI-RS) with CSI-RS resource ID; and (d) RSRP of Demodulation Reference Signal (DM-RS).

As discussed herein, the network may include AMF, Location Management Function (LMF), Next Generation Node B (gNB), or Next Generation Radio Access Network (NG-RAN). Further, in this discussion the terms “Pre-configuration” and “configuration” may be used interchangeably. Also, “non-serving gNB” and “neighboring gNB” may be used interchangeably. The terms “gNB” and (Transmission Reception Point) “TRP” may be used interchangeably. In this disclosure “DL-RS”, “DL-RS(s)”, “DL-RS resources” and “DL-RS resource(s)” may be used interchangeably in this disclosure. Further, “DL-RS(s)” or “DL-RS resource(s)” may belong to different DL-RS resource sets.

In addition to the above, in this disclosure, the terms “Measurement gap” and “Measurement gap pattern” may be used interchangeably, while the term “Measurement gap pattern” may include parameters such as measurement gap duration, measurement gap repetition period or measurement gap periodicity.

In the present disclosure, the term LMF is a non-limiting example of a node or entity (e.g., network node or entity) that may be used for or to support positioning or sensing. Any other node or entity may be substituted for LMF and still be consistent with this disclosure. The WTRU may receive a preconfigured threshold(s) from the network (e.g., LMF, gNB). The LOS indicator may be hard (e.g., 1 or 0) or soft indicator (e.g., 0, 0.1, 0.2 . . . , 1) and it indicates likelihood of the presence of an LOS path between TRP and WTRU or along DL-RS. For example, the WTRU may receive a request from the network to report an LOS indicator for the DL-RS. The WTRU may determine the LOS indicator for the DL-RS based on measurements. The determined LOS indicator may be associated with AoD or AoA of the DL-RS. The LOS indicator may be associated with a TRP or PRS resource identifier (ID) (e.g., index). The WTRU may receive the LOS indicator from the network per TRP or resource ID. Alternatively, the WTRU may determine the LOS indicator per TRP, or resource ID based on measurements. Similarly, the NLOS indicator indicates likelihood of the presence of an NLOS path between TRP and WTRU or along DL-RS.

In the examples and embodiments described herein, “ID” and “index” may be used interchangeably. The terms “training” and “data collection” may also be used interchangeably. The terms “SRS”, “SRSp” or “SRS for positioning” may be used interchangeably. Further, in the examples and embodiments described herein, the terms “WTRU-side condition”, “WTRU condition” or “WTRU implementation” may be used interchangeably.

A WTRU location may be expressed in terms of altitude, latitude, geographic coordinate, or local coordinate. In the examples and embodiments, a timestamp be indicated by absolute time, relative time (e.g., in seconds) compared to a reference time, SFN, slot index, frame index, subframe index and/or symbol index. Examples of “absolute time” may be UTC time, GNSS time, locally defined absolute time (e.g., LTE or NR Time). Further, the WTRU may receive configurations for a time window such as duration (e.g., expressed in terms of seconds, number of symbols, number of slots, number of frames, number of subframes), start and/or end time (e.g., expressed in terms of absolute time, system time, relative time with respect to a reference time indicated by the network or determined by the WTRU, SNF index, slot index, symbol index, frame index, subframe index). The WTRU may receive more than one configuration of a time window where each configuration is associated with an index. The time window may be initiated with a trigger sent by the network. For example, the WTRU may receive a command (e.g., DCI) to initiate an indicated time window, indicated via the configuration index. The WTRU may determine to initiate the time window after a configured duration after reception of the command (e.g., N symbols, N slots, N frames, N seconds). The WTRU may receive an activation or deactivation command (e.g., DCI, MAC-CE) to activate or deactivate the time window, respectively, from the network.

In an operative embodiment, a WTRU may receive configurations for reference signals (RS). The WTRU may receive DL-RS and/or UL-RS (e.g., Sounding Reference Signal (SRS)) configurations for positioning purposes from the network (e.g., LMF). The LMF may forward the PRS configuration and SRS configurations to the gNB so that the gNB may schedule PRS transmission or SRS reception at the TRP, TP and/or RP.

An example of a DL-RS configuration may contain at least one of the following parameters: number of symbols, transmission power, number of DL-RS resources included in DL-RS resource set, muting pattern for DL-RS (for example, the muting pattern may be expressed via a bitmap), periodicity, type of DL-RS (e.g., periodic, semi-persistent, or aperiodic), slot offset for periodic transmission for DL-RS, vertical shift of DL-RS pattern in the frequency domain, time gap during repetition, repetition factor, RE (resource element) offset, comb pattern, comb size, spatial relation (e.g., with respect to other DL-RSs or UL RS such as SRS for positioning purpose), Quasi Co-Location (QCL) information (e.g., QCL target, QCL source) for DL-RS, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for DL-RS transmission, on/off indicator for DL-RS, TRP ID, DL-RS ID, cell ID, global cell ID and applicable time window. The WTRU may apply a DL-RS configuration under a condition that the current time is within the applicable time window. “ID” may be used interchangeably with “index”. Further examples of DL-RS are CSI-RS, PTRS, PRS, TRS, and SSB.

An example of an UL-RS or SRS configuration may include at least one of: resource ID; comb offset values, cyclic shift values; start position in the frequency domain; number of UL-RS symbols; shift in the frequency domain for UL-RS; frequency hopping pattern; type of UL-RS (e.g., aperiodic, semi-persistent or periodic); sequence ID used to generate UL-RS, or other IDs used to generate UL-RS sequence; spatial relation information, indicating which reference signal (e.g., DL RS, UL RS, CSI-RS, SRS, DM-RS) or SSB (e.g., SSB ID, cell ID of the SSB) the UL-RS is related to spatially where the UL-RS and DL RS may be aligned spatially; QCL information (e.g., a QCL relationship between UL-RS and other reference signals or SSB); QCL type (e.g., QCL type A, QCL type B, QCL type C, QCL type D); resource set ID; list of UL-RS resources in the resource set; transmission power related information; pathloss reference information which may contain index for SSB, CSI-RS or DL-RS; periodicity of UL-RS transmission; bandwidth; carrier component ID; and/or spatial information such as spatial direction information of UL-RS transmission (e.g., beam information, angles of transmission), spatial direction information of DL RS reception (e.g., beam ID used to receive DL RS, angle of arrival). “ID” may be used interchangeably with “index”. Further examples of the UL-RS include SRS and SRS for positioning purposes.

In 3GPP, the various categories of WTRU positioning techniques are specified, for example, in 3GPP TS 38.305 v18.3.0, Section 4, 2024/09, which is herein incorporated by reference. In one example, a “DL positioning method” may refer to any positioning method that uses downlink reference signals such as PRS. The WTRU may receive one or more reference signals from TP(s) and measures DL RSTD and/or RSRP. Examples of DL positioning methods are DL-AoD or DL-TDOA positioning. A “UL positioning method” may also refer to any positioning method that uses uplink reference signals such as SRS for positioning. The WTRU transmits SRS to one or more RPs and the RPs measure the UL RTOA and/or RSRP. Examples of UL positioning methods are UL-TDOA or UL-AoA positioning. A “DL & UL positioning method” may refer to any positioning method that uses both uplink and downlink reference signals for positioning. In embodiments, a WTRU may transmit SRS to one or more TRPs and gNB measures Rx-Tx time difference which is calculated based on the time of arrival of DL RS (e.g., PRS). The gNB may measure RSRP for the received SRS. The WTRU measures Rx-Tx time difference for PRS transmitted from one or more TRPs. The WTRU may measure RSRP for the received PRS. The Rx-TX difference and possibly RSRP measured at WTRU and gNB are used to compute round trip time. Here “WTRU Rx-Tx time difference” refers to the difference between arrival time of the reference signal transmitted by the TRP and transmission time of the reference signal transmitted from the WTRU. An example of DL & UL positioning method may also include multi-RTT positioning.

An example of measurement may be a channel impulse response. A channel impulse response, consisting of N paths, may be defined by the following equation:

$$h ( t ) = {\sum }_{k = 1}^{N} {h}_{k} ( t ) δ ( t - {τ}_{k} ) \qquad ( 1 )$$

where hₖ(t) and tₖ are time-varying complex valued coefficient (e.g., expressed by a+bj where j=\sqrt{−1} for the channel impulse response and delay, measured in seconds, for the k^{th} path, respectively. The delta function is defined as δ(t)=1 for t=0 and δ(t)=0 for t≠0.

In the disclosure, it is assumed that the coefficients are constant over time, e.g., hₖ(t)=hₖ. The WTRU may report hₖ and tₖ for each path k to the network. The WTRU may report the number of paths, N, to the network. Alternatively, the WTRU may receive hₖ and tₖ for each path k from the network and/or the number of paths.

In embodiments, the WTRU may obtain CIR (Channel Impulse Response) from the network. The network may indicate DL-RS configuration(s) such as DL-RS resource IDs associated with the CIR. For example, the CIR may be associated with DL-RS resource ID. In this case, the WTRU may determine that the CIR is derived based on the measurements made on the DL-RS resource associated with the ID. Alternatively, the WTRU may determine that the channel along the direction of transmission of the DL-RS or reception of the DL-RS corresponds to the CIR.

In embodiments, the CIR may be associated with a TRP ID. In this case, the WTRU may determine that the CIR represents the channel between the associated TRP and WTRU. As an example, the CIR may be associated with more than one TRPs where the network may include TRP indices associated with the CIR. Alternatively, the CIR may be associated with a cell. In this example, the WTRU may receive cell ID or index associated with the CIR from the network. In embodiments, the CIR may further be associated with more than one TRPs or DL-RS resource IDs. In this example, the WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

In embodiments, more than one CIRs may be associated with one parameter from DL-RS configurations (e.g., TRP ID, DL-RS resource ID, frequency layer ID. For example, the WTRU may receive information related to 2 CIRs associated with a TRP from the network, e.g., the following equations:

$${h}_{1} ( t ) = {\sum }_{k = 1}^{{N}_{1}} {h}_{1 , k} ( t ) δ ( t - {τ}_{1 , k} ) \qquad ( 2 )$$

$$and$$

$${h}_{2} ( t ) = {\sum }_{k = 1}^{{N}_{2}} {h}_{2 , k} ( t ) δ ( t - {τ}_{2 , k} ) . \qquad ( 3 )$$

Alternatively, the WTRU may report information related to more than one CIRs associated with DL-RS configuration (e.g., TRP ID, DL-RS resource ID) based on the measurements to the network. There may be more than one CIRs associated with DL-RS configuration since the WTRU or network may observe different channel characteristics based on AoA of DL RS or UL RS, for example.

Channel impulse response may be represented by DP (delay profile) or PDP (power delay profile). A power delay profile may be defined as a set of delays and power profiles, such as [t₀, t₁, . . . , t_{(N-1)}] and [p₀, p₁, . . . , p_{(N-1)}], where pk may corresponds to relative power at the k^{th} path compared to the first path. A delay profile may be defined as a set of delays [t₀, t₁, . . . , t_{(N-1)}] which indicates path delay for each path above p_{threshold}. The WTRU may receive p_{threshold} from the network to derive delay profile from power delay profile.

In embodiments, the channel impulse response the WTRU reports to the network may be defined by configured number of samples (e.g., N) where the WTRU is configured with granularity of samples (e.g., X seconds apart). The number of samples may be defined within a window. The WTRU may report samples whose RSRP is over the configured threshold or M highest RSRP among the samples. The WTRU may indicate locations or sample index of samples where the WTRU measures M highest RSRP samples. The first sample may be defined as the earliest arriving path, e.g., first path. In embodiments, the samples may be defined with respect to the reference timing (e.g., ToA of reference or indicated DL-RS, ToA of the earliest arriving DL-RS). The WTRU may report timing, phase and/or power information per sample. The determined reference timing or first path may be rounded up or down to the defined timing granularity. The channel impulse response, PDP or DP may be defined as the impulse response between WTRU and TRP or associated with a DL-RS (e.g., DL-RS resource ID) or DL-RS resources (e.g., DL-RS resource IDs).

In embodiments, the WTRU may receive an indication from the network on how to generate CIR, PDP or DP based on timing, phase and/or power measurements. In embodiments, the WTRU may send a request to the network to receive an indication on which methodologies to use to generate CIR, PDP or DP based on the measurements the WTRU made. For example, the WTRU may receive a message from the network (e.g., via LPP, RRC, MAC-CE, DCI) indicating the DL-RS resource indices and associated measurement type(s) (e.g., RSTD, AOA) to use to generate CIR, PDP or DP. In embodiments, the WTRU may receive an indication from the network indicating to generate CIR, PDP or DP.

In embodiments, the WTRU may receive a threshold (e.g., power threshold) from the network and timing range (e.g., 0 μs to 1 μs), timing granularity (e.g., every 0.1 μs in the indicated timing range, 100 sample points in the indicated timing range) of CIR, PDP and/or DP. In this case, the WTRU may determine to report power and timing (e.g., relative timing compared to a reference timing, absolute timing) any samples whose received power is over the threshold.

The WTRU may send measurements in a report to the network (e.g., LMF, gNB) via a semi-static (e.g., LPP, RRC) or dynamic message (e.g., UCI, UL MAC-CE). Further, in the examples and embodiments herein, DL-RS (e.g., CSI-RS, DM-RS, TRS) and SSB may be used interchangeably.

Artificial intelligence (AI) or machine learning (ML) may be broadly defined as the behavior exhibited by machines that mimics cognitive functions to sense, reason, adapt, act, and provide the ability to discern patterns. In examples and embodiments, AI and/or ML may be used for determining positioning.

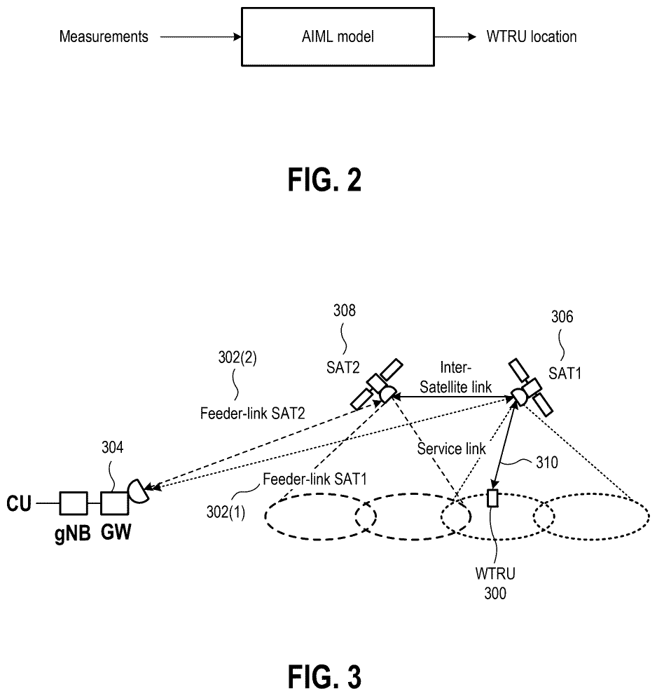

In FIG. 2 there is shown an illustration of using an AI/ML model to obtain WTRU location. In this figure, the WTRU inputs the AI/ML model with measurements (e.g., timing, phase, power measurements such as RSTD, time of flight, ToA, ToD, carrier phase measurement, carrier phase difference measurement, RSRP, RSRP per path) and the WTRU obtains the WTRU location from the AI/ML model. The output of the AI/ML model may be referred to as “inference”.

As an input to the AI/ML model, if the AI/ML model is associated with or trained with measurements from more than one TRPs, the WTRU may use measurements made from more than one TRPs. If the AI/ML model is trained with measurements from more than one TRPs, the WTRU may receive an indication or configuration from the network about identification information about the TRPs (e.g., TRP IDs, PRS IDs) the AI/ML model is trained with. In the examples and embodiments described herein, the terms “AIML” and “AI/ML” may be used interchangeably.

Examples of inputs for an AI/ML model for positioning may include one or more of the following: (i) an RSRP of PRS resource(s), (ii) a statistical measure of RSRP (e.g., mean, variance etc.) per PRS resource(s), (iii) a maximum or minimum value of RSRP per PRS resource(s), (iv) an RSRP of PRS resource(s) per path, (v) an RSRP of PRS resource(s) per antenna port, (vi) an RSCP of PRS resource(s) per path, (vii) an RSCP of PRS resource(s) per antenna port, (viii) an RSTD and/or RSCPD of PRS resource(s), (ix) a statistical measure of RSTD per PRS resource(s), (x) a maximum or minimum value of RSTD per PRS resource(s), (xi) an RSTD and/or RSCPD of PRS resource(s) per path, (xii) an RSTD and/or RSCPD of PRS resource(s) per antenna port, (xiii) a time of arrival per PRS resource(s), (xv) a time of arrival per PRS resource(s) per path, (xvi) a time of arrival per PRS resource(s) per port, (xvii) a statistical measure of Time of arrival per PRS resource(s), (xviii) a maximum or minimum value of time of arrival per PRS resource(s), (xix) a CIR (channel impulse response) estimated based on DL-RS(s) (e.g., PRS, CSI-RS, DM-RS) where CIR may be associated with a TRP or TRPs, (xx) a PDP (power delay profile) estimated based on DL-RS(s) (e.g., PRS, CSI-RS, DM-RS) where CIR may be associated with a TRP or TRPs, and (xxi) a DP (delay profile) estimated based on DL-RS(s) (e.g., PRS, CSI-RS, DM-RS), where the CIR may be associated with a TRP or TRPs.

Non-terrestrial networks (NTN) may be used to facilitate deployment of wireless networks in areas where land-based antennas are impractical, for example due to geography or cost. It is envisioned that, coupled with terrestrial networks, NTN will enable truly ubiquitous coverage of 5G networks. Initial Rel-17 NTN deployments support basic talk and text anywhere in the world; however, it is expected that further releases coupled with proliferation of next-generation low-orbit satellites will enable enhanced services such as web browsing.

A basic NTN consists of an aerial or space-borne platform which, via a gateway (GW), transports signals from a land-based based gNB to a WTRU and vice-versa. Current Rel-17 NR NTN supports power class 3 WTRU with omnidirectional antenna and linear polarization, or a very small aperture antenna (VSAT) terminal with directive antenna and circular polarization. Support for LTE-based narrow-band IoT (NB-IoT) and eMTC type devices are also standardized in Rel-17. Regardless of device type, it is assumed all Rel-17 NTN WTRUs are GNSS capable.

There may be a number of NTN deployment scenarios. For example, Aerial or space-borne platforms are classified in terms of orbit, with Rel-17 standardization focusing on low-earth orbit (LEO) satellites with altitude range of 300-1500 km and geostationary earth orbit (GEO) satellites with altitude at 35 786 km. Other platform classifications such as medium-earth orbit (MEO) satellites with altitude range 7000-25000 km and high-altitude platform stations (HAPS) with altitude of 8-50 km are assumed to be implicitly supported. Satellite platforms are further classified as having a “transparent” or “regenerative” payload. Transparent satellite payloads implement frequency conversion and RF amplification in both uplink and downlink, with one or more transparent satellites possibly connected to one land-based gNB. Regenerative satellite payloads may implement either a full gNB or gNB DU onboard the satellite. Regenerative payloads may perform digital processing on the signal including demodulation, decoding, re-encoding, re-modulation and/or filtering.

As exemplified in FIG. 3, there may be multiple radio or other interfaces defined within the area of a WTRU 300. These interfaces may include a feeder-link 302, a wireless link between the GW 304 and one or more satellites 306, 308, a service link 310, a radio link between satellite 306 and the WTRU 300, or an inter-satellite Link (ISL) 312: is a transport link between satellites 306, 308. The ISL may be supported only by regenerative payloads and may be a 3GPP radio or proprietary optical interface.

Depending on the satellite payload configuration, different 3GPP interfaces are used for each radio link. In a transparent payload, the NR-Uu radio interface is used for both the service link and feeder-link. For a regenerative payload, the NR-Uu interface is used on the service link, and a satellite radio interface (SRI) is used for the feeder-link. 3GPP has not currently defined ISLs for 3GPP, Rel-17.

An NTN satellite may support multiple cells, where each cell consists of one or more satellite beams. Satellite beams cover a footprint on earth (like a terrestrial cell) and may range in diameter from 100-1000 km in LEO deployments, and 200-3500 km diameter in GEO deployments. Beam footprints in GEO deployments remain fixed relative to earth, and in LEO deployments the area covered by a beam/cell changes over time due to satellite movement. This beam movement may be classified as “earth moving” where the LEO beam moves continuously across the earth, or “earth fixed” where the beam is steered to remain covering a fixed location until a new cell overtakes the coverage area in a discrete and coordinated change.

Due to the altitude of NTN platforms and beam diameter, the round-trip time (RTT) and maximum differential delay is significantly large than that of terrestrial systems. In a typical transparent NTN deployment, RTT may range from 25.77 ms (LEO @ 600 km altitude) to 541.46 ms (GEO) and maximum differential delay from 3.12 ms to 10.3 ms. The RTT of a regenerative payload is approximately half that of a transparent payload, as a transparent configuration consists of both the service and feeder links, whereas the RTT of a regenerative payload considers the service link only. To minimize impact to existing NR systems (e.g. to avoid preamble ambiguity or properly time reception windows), prior to initial access a WTRU performs timing pre-compensation.

Considering the above, AI/ML based positioning may use fingerprints in measurements. It may be assumed that the WTRU makes measurements on PRSs transmitted from satellites. Based on the measurements, the WTRU trains the AI/ML model(s) at the WTRU. In embodiments, for AI/ML based positioning to be effective, consistency needs to be achieved between training and inference phase. One PRS beam from a satellite (geo stationary, for example) may cover a very large area. Conventional positioning techniques (e.g., GNSS, or terrestrial positioning) are not typically effective in NLOS conditions. Moreover, training an AI/ML model for positioning that may cover the entire coverage of one satellite PRS beam (e.g., covering one country) may require an extremely large AI/ML model. It may be advantageous for the WTRU to reduce the AI/ML model complexity and maintain consistency, with respect to the area, between collected data and inference for satellite-based positioning.

In an embodiment, the WTRU may determine a validity area for positioning and report the determined validity area to the network. The WTRU may then receive additional assistance information and PRS configuration based on the reported validity area. Upon receipt of the assistance information the WTRU may perform positioning within the validity area.

The steps in the above embodiment may be more specifically defined for a MO-LR, where the WTRU determines the positioning accuracy requirement based on a triggering condition (e.g., the need for timing compensation for NTN, emergency call, acquiring WTRU location for NW verification). The WTRU may send a request for PRS configuration and assistance information for WTRU-based positioning. The WTRU further receive, from the network, assistance information (e.g., atmospheric condition, ephemeris). The WTRU may also receive a request from the network to report validity area for AI/ML positioning. The WTRU may determines the validity area for AI/ML positioning based on the WTRU location (e.g., terrestrial cell ID). If the WTRU cannot determine its location based on cell information, the WTRU may send a request for PRS configuration via a satellite link. The WTRU may also determine the validity area based on environmental conditions (e.g., atmospheric condition), an accuracy requirement, or the LOS condition(s) with the satellite(s). The WTRU may report the determined validity area to the network. The WTRU report may optionally also include the satellites used to determine the validity area, or the WTRU location, accuracy requirement and determined LOS condition with the satellites.

In the above, the WTRU may determine a validity area for positioning. The WTRU may report the determined validity area to the network. The WTRU may receive additional assistance information and PRS configuration based on the reported validity area. Based on the assistance information and/or the PRS configuration, the WTRU may perform positioning within the validity area.

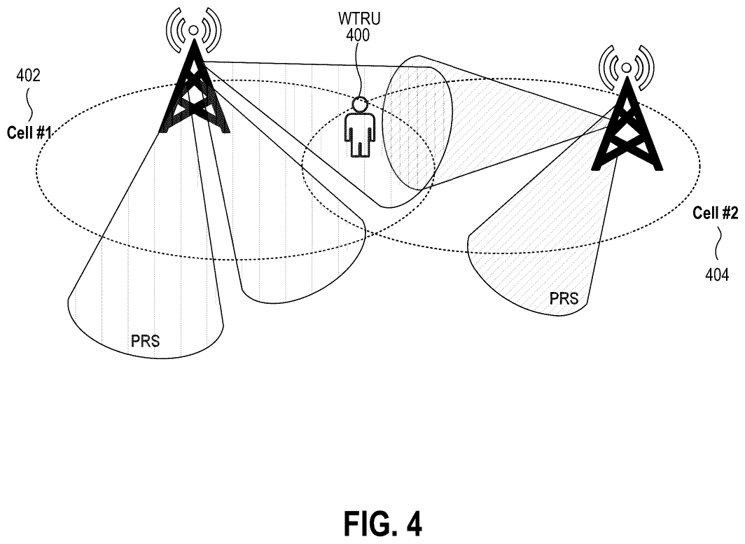

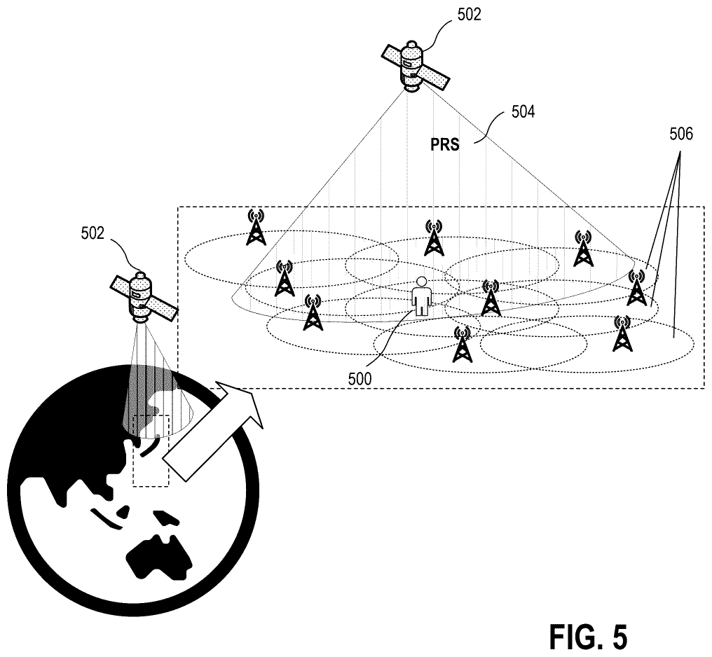

In an embodiment of terrestrial positioning, such as that shown in FIG. 4, certain information may need to be consistent during the data collection phase configuration and inference phase by or for the WTRU 400: (1) the PRS configurations (e.g., PRS bandwidth, TRP IDs, PRS resource IDs), and (2) the configured area (e.g., cell #1 402+ cell #2 404) for which PRS configs are valid, i.e., validity area may be determined from the PRS configuration (e.g., from TRP ID, cell ID in the PRS config). Examples of the need to be consistent between data collection phase config and the inference phase include: (A) PRS configuration (e.g., PRS bandwidth, PRS resource ID for the PRS beam), and (B) the determined validity area within the PRS beam (e.g., due to large complexity, an AI/ML model cannot cover entire area covered by one PRS beam, and the WTRU or network may need to determine the validity area). In FIG. 5 there is provided an illustration of a satellite 502 providing positioning using a PRS beam 504. The satellite beam 504 addresses various terrestrial based cells 506, for which only a portion are able to communicate with the WTRU 500.

Training phase or inference phase may be indicated by the network (e.g., LMF), explicitly and/or determined by the WTRU implicitly. In embodiments, the training phase may be defined by the duration during which the WTRU or training entity may receive PRS and trains an AI/ML model with measurements and associated ground truth. The training phase may be terminated by the network or by the request (e.g., indicating that training is complete, or the WTRU received trained AI/ML models) from the WTRU or training entity.

In embodiments, the inference phase may be defined by the duration where the WTRU uses the trained AI/ML model(s) to generate inference. The inference phase may start when the WTRU receives, from the network, a request for reference (e.g., WTRU location). In embodiments, the inference phase may start when the WTRU requests, from the network, for location information, transmission of PRS, assistance information, and/or PRS configuration.

In embodiments, the training phase and inference phase may overlap in time. For example, the OTT server or WTRU may be training AI/ML models as the WTRU generates inference as per request from the network.

In embodiments, the WTRU may receive from the AI/ML model training entity, the parameters for the trained AI/ML model (e.g., weights) and meta data for the AI/ML model. The meta data may contain PRS configurations, assistance information and association information used during the training phase.

In embodiments, an AI/ML model training entity (e.g., WTRU, OTT, NW) needs to train an AI/ML model using measurements or data (e.g., CIR) derived from the measurements. Training an AI/ML model may require measurements.

In the examples and embodiments herein, “training” and “data collection” may be used interchangeably. During the training phase, the entity may collect measurements based on the received DL RS and/or from other entities (e.g., WTRU, OTT, NW). Using the collected measurements, the entity may train an AI/ML model. A WTRU may obtain the trained AI/ML model from the entity.

Assistance information related to network implementations provided by the network may be important for the AI/ML model training entity (e.g., WTRU, OTT, NW) since it indicates the conditions under which the AI/ML model is trained. For example, the conditions may include at least one of the following: (a) the TRP location, (b) the angle in antenna or antenna panels at TRPs, (c) the location of antenna or antenna panels at TRPs, (d) the synchronization error among gNBs and/or TRPs, (e) the beam shape, beam width, (f) the Boresight direction of a beam, (g) the characteristics of hardware or software at the network, such as characteristics of an amplifier used for transmission, number of antenna elements at Tx or Rx, number of panels, etc., and (h) the timing, power and/or phase offset in signals transmitted by a TRP.

The acquisition of assistance information may include determination of positioning accuracy requirements, a request from the US for positioning, and receipt of the requested assistance information.

In one example of determining the position accuracy requirements, for mobile originated location request (MO-LR), the WTRU may determine positioning accuracy requirements based on the trigger for the request. Examples of use cases that may trigger the location request may include at least one of the need for timing compensation for NTN (Non terrestrial network), an emergency call, and acquiring WTRU location for NW verification.

In embodiments, the WTRU may receive, from the network (e.g., LMF, gNB), accuracy requirements for use cases. For example, the use case related to timing compensation may require accuracy in the order of several kilometers while the use case for emergency call may require the order of several meters of accuracy.

In embodiments of a request from the WTRU for positioning, the WTRU may determine to send a request for positioning. The WTRU may send a message, via LPP, RRC, UCI or MAC-CE, for example, to the network (e.g., LMF, gNB). The message may contain at least one or a combination of the request for WTRU-based positioning, request for assistance information for satellites (e.g., mobile TRP), the request for PRS configurations for NTN or TN, and the cause of the request (e.g., emergency call, need for timing compensation).

In embodiments of assistance information, the WTRU may receive assistance information from the network. The WTRU may receive assistance information via broadcast (e.g., via SIB), multi-cast or unicast. The WTRU may receive assistance information from terrestrial network or non-terrestrial network. Assistance information may contain at least one or a combination of the following: (a) ephemeris of satellites (e.g., trajectory of a satellite, expected time of visibility of a satellite), (b) information related to satellite (e.g., satellite ID, type of satellites such as LEO, GEO), (c) environmental information (e.g., troposphere, ionosphere condition, expected uncertainty in measurements (e.g., power, timing or phase measurements), expected delay or phase shift in measurements, range in delay or phase shift in measurements, expected or range of received power fluctuations), (d) area information environmental information is applicable (e.g., zone ID, cell ID, area indicated by geographical coordinates), and (e) a timestamp.

In embodiments related to assistance information, the WTRU may receive PRS configurations from the network. The WTRU may receive, for example, PRS resource ID, spatial information of PRS, information related to how PRS is generated (e.g., sequence ID), etc. In embodiments, the WTRU may receive PRS configurations and associated assistance information from the network via broadcast (e.g., SIB, posSIB), multi-cast or unicast.

In embodiments, the WTRU may receive assistance information at different time instances. For example, the WTRU may receive first assistance information related to environmental conditions for determining the validity condition. The WTRU may receive second assistance information that may contain information to receive PRS (e.g., PRS configurations such as PRS resource ID, sequence ID, frequency layer ID, etc.).

In embodiments, the network may request details of a validity area and definitions of validity area. In embodiments, the WTRU may receive, from the network, a request to report validity area. Examples of the definition of the validity area may be one or more of the area in which the WTRU can perform satellite-based positioning (e.g., NTN based positioning), the area in which the WTRU can perform satellite-based AI/ML-based positioning, the area in which the WTRU can determine its location using a combination of satellite-based positioning and AI/ML-based positioning, and the area in which the WTRU can determine its location using a combination of satellite-based positioning, AI/ML-based positioning and terrestrial based positioning.

In embodiments, the WTRU may receive a message from the network to report at least one of the following: (a) the validity area and/or assistance information related to validity area (e.g., cell IDs, geographical coordinates, configured zone IDs), (b) a Timestamp, (c) the time validity for the validity area (e.g., duration of validity for the reported validity area), (d) the WTRU location, method(s) used to determine the WTRU location (e.g., based on cell ID, GNSS), and (e) the WTRU capability, e.g., memory size, computational power, computational complexity the WTRU's hardware can support, largest size of an AI/ML model the WTRU can support, number of AI/ML models the WTRU can support, supported battery power, remaining battery power, whether or not the WTRU is mobile.

In embodiments, the WTRU may determine to send information related to AI/ML model(s) to the network. The WTRU may receive a request from the network to send information related to AI/ML model(s).

In embodiments, an AI/ML model may be associated with at least one or combination of a number of factors. For example, the parameter(s) in PRS configuration (e.g., PRS ID, cell ID, TRP ID, frequency information such as frequency layer ID, ARFCN) may for part of the association. The parameter(s) in SRS or SRSp configuration (e.g., SRS sequence ID), the cell ID, and the area which may be defined by more than one cell IDs and area may be associated with an ID, e.g., area ID may also be AI/ML associated. More than one parameter, for example, an AI/ML model may be associated with more than one TRPs or cell IDs, indicating that the AI/ML model can be used with the measurements made on the associated TRPs or cell IDs. Other associated factors may include the ID related to RS or signals (e.g., CSI-RS ID, DM-RS ID, SSB ID), the input information and/or type thereof, the output information and/or type thereof, the model version information, the model format information and/or type thereof, and the AI/ML capability (e.g., AI/ML positioning, AI/ML beam management) which may be defined at finer granularities (e.g., AI/ML direct positioning, AI/ML assisted positioning, AI/ML spatial domain beam prediction, AI/ML temporal domain beam prediction, etc.). Additional factors may include vendor information (e.g., vendor ID), applicable scenario and/or configuration (e.g., frequency range, antenna configuration, site information, cell ID, etc. in which AI/ML model is applicable for inference, based for example on matching with the training scenario), computational complexity, e.g., FLOPs, level of pre-/post-processing that may be needed before deploying the model and/or before using the model for inference, complexity, e.g., number of real-value model parameters, number of real-value operations for the model, number and/or ID representing model complexity in terms of any of the aforementioned parameters, and size, e.g., fixed sizes associated with some models, e.g., ≤5 MB, ≤50 MB, ≤100 MB, etc. Other AI/ML associated factors may include a performance metric, e.g., accuracy, bias, variance and/or number/ID associated to any thereof, the functionality and/or sub-functionality and/or use case and/or sub use case, e.g., what (sub) functionality and/or (sub) use cases are applicable for a specific model, e.g., CSI/BM/positioning, the applicable types of a specific model, e.g., WTRU-sided model, WTRU-part of a two-sided model (e.g., encoder at WTRU, decoder at gNB for CSI compression use case), and the model monitoring method.

In embodiments, the WTRU may determine the validity area based on at least one or combination of the following: (a) WTRU location (e.g., terrestrial cell ID, location determined based on a positioning method such as GNSS), (b) WTRU capability (e.g., size of AI/ML model(s) that the WTRU can support, memory size, battery power), (c) environmental factors (wherein, for example, the WTRU may determine the validity area over which the atmospheric condition is constant; and the WTRU may receive candidates for validity area in the assistance information from the network where the network area indicates area over which the WTRU should expect constant atmospheric conditions or constant environmental effect on measurements), (d) the accuracy requirement (wherein for example, the WTRU may be configured with association between the accuracy requirement and validity area size, e.g., associated validity area for emergency calls is one cell, and the WTRU may determine the validity area based on the accuracy requirement and/or use case.), (e) the available satellites (wherein, for example, the WTRU may determine satellites to make measurements from, e.g., measurements obtained from the received reference signals from the satellite, based on the ephemeris provided by in assistance information, and the WTRU may also determine available satellites based on the WTRU location), (f) the LOS condition (wherein, for example, the WTRU may determine LOS status with a satellite provided in the ephemeris in assistance information; the determined LOS status may be expressed in terms of a hard indicator (e.g., 1 for LOS, 0 for NLOS) or soft indicator (e.g., 0.8 for high likelihood of LOS, 0.2 for low likelihood of NLOS, 0.5 for equally like to be LOS or NLOS); and the WTRU may determine the validity area in which the WTRU has satellites with the associated LOS indicator above the configured threshold (e.g., LOS indicator has to be 1, LOS indicator greater than 0.7)), (g) the PRS configurations (wherein for example, the WTRU may determine validity area based on geographical coverage of a PRS (e.g., based on PRS resource ID), or spatial direction of PRS transmitted from a satellite; and the WTRU may determine the validity area based on geographical coverage of more than one PRSs transmitted from different satellites), and (h) the PRS measurements (wherein the WTRU may make measurements on the received PRS and based on the measurements (e.g., RSRP) the WTRU may determine validity area, e.g., the WTRU may determine the validity area within which the measurements for the received PRS (e.g., RSRP) are above a configured threshold, with the WTRU potentially determining (1) the validity area where the WTRU can receive measurements above the configured threshold for more than one PRSs (for example, the WTRU may be configured with the minimum number of satellites or PRSs which the WTRU needs to use for positioning purposes) and (2) the validity area in which the WTRU can make measurements from at least the configured number of PRSs and/or satellites where the measurement is above the configured threshold).

In embodiments, the WTRU may send a request for assistance information, PRS configurations or PRS transmission to the network. The WTRU may include preferred assistance information or PRS configurations in the request. The WTRU may receive a response from the network, which may contain assistance information and/or PRS configurations. The WTRU may receive PRS from the network as the response to the request.

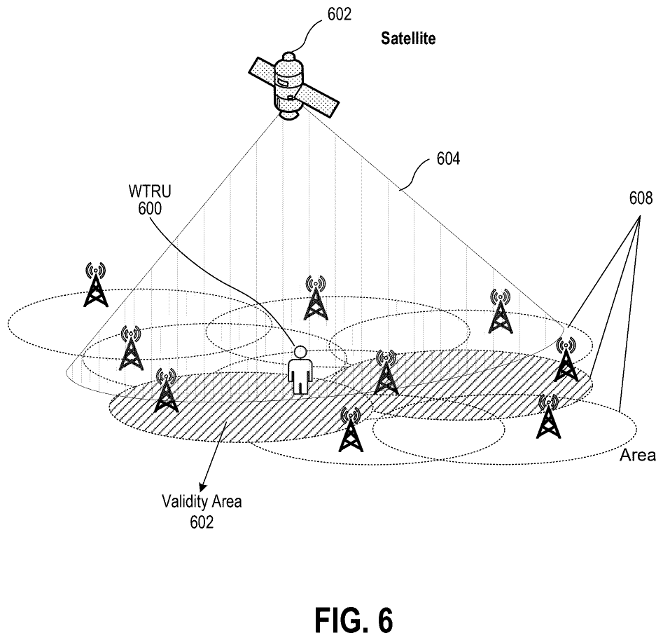

A defined validity area 602 is illustrated in FIG. 6, wherein the PRS beam 604 from the satellite 606 may cover more than one area or, e.g., terrestrial cell 608. The WTRU 600 may determine the validity area 602 (e.g., the shaded area in FIG. 6) based on its location and its capability, and wherein the validity area may be a subset of the overall area covered by the PRS beam 604 from the satellite 602.

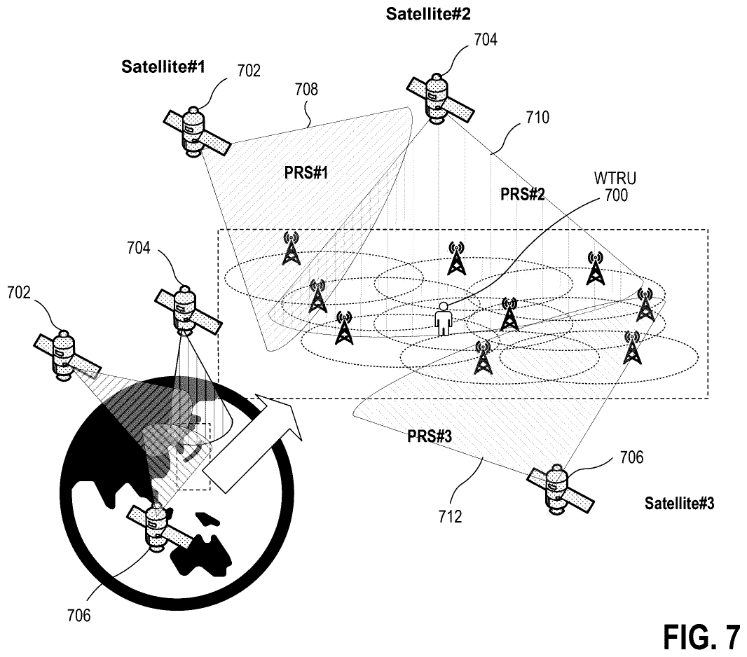

FIG. 7 shows the WTRU 700 receiving multiple PRSs 708, 710, 712 from more than one satellite 702, 704, 706. In embodiments, the WTRU 700 may determine the validity area based on the one of the PRSs or multiple PRSs received from various satellites. In embodiments, the WTRU may determine the validity area based on coverage of more than one satellites (e.g., based on the intersection of coverage of the satellites).

In embodiments, the WTRU may determine the validity area based on more than one criterion (e.g., based on environmental factors and available satellites). The WTRU may determine a different size of the validity area for each criterion. The WTRU may further determine to use the smallest validity area among the potential validity areas.

In other embodiments, the network may determine the validity area. For example, the WTRU may send a request to the network for configuration of a validity area. The WTRU may include in the request the WTRU capability, which may include AI/ML capability information. The WTRU may also include its location information. Further, the WTRU may receive, from the network, a request to report on its location. The WTRU may determine its location based on a known positioning method (e.g., GNSS) or based on terrestrial cellular information (e.g., cell ID). The WTRU may receive validity area from the network based on the reported location information. The WTRU may determine to request for configuration and/or request the validity area based on the application or use case that triggers the request for positioning. For example, low-latency applications-such as an emergency call—may require the WTRU to obtain validity information quickly. In such a case, the WTRU may determine to request the network for the validity area.

In embodiments, the WTRU may receive the validity area based on the reported validity area. For example, the WTRU may receive a request, from the network, to report on the determined validity area. The WTRU may send the determined validity area and receive from the network as the response, the designated or configured validity area. The WTRU may then use the validity area configured by the network.

In embodiments, the WTRU may send a request that contains the desired validity area. As the response for this request, the network may send configurations related to the validity area to the WTRU. The validity area configured by the network may be same or different from the validity area requested by the WTRU. In embodiments, the WTRU may send, to the network, a request for validity area. The WTRU may receive the validity area. As a response, the WTRU may send the determined or preferred validity area back to the network.

In embodiments, the WTRU may receive a request from the network to report its location and/or measurements made on the PRS. The WTRU may report to the network at least one of or a combination of the following in the measurement report: (i) the PRS ID associated with measurements and/or WTRU location estimate, (ii) the TRP ID associated with measurements and/or WTRU location estimate, (iii) the cell ID associated with measurements and/or WTRU location estimate, (iii) the ARFCN associated with measurements and/or WTRU location estimate, (iv) the PRS Resource ID(s) associated with measurements and/or WTRU location estimate, (v) the PRS Resource Set ID(s) associated with measurements and/or WTRU location estimate, (vi) the frequency layer ID(s) associated with measurements and/or WTRU location estimate, (vii) the timestamp indicating when the measurements are made or when the report is made, (viii) the RSTD associated with PRS resource ID(s) for each path in multipaths, (ix) the RSRP associated with PRS resource ID(s) for each path in multipaths, (x) the phase measurement (e.g., RSCP, RSCPD) for each path in multipaths, (xi) the uncertainty information (e.g., expressed in terms of a range such as +2 μs) or quality information (e.g., indicating whether the indicated measurement is in the unit of 0.1 μs or 0.01 μs) for measurements, (xii) the TEG (timing error group) associated with measurements or PRS resource ID or PRS resource set ID, (xiii) the LOS indicator associated with PRS resource ID or TRP ID, (xiv) the WTRU location (e.g., absolute location with geographical coordinates expressed by x and y coordinates, relative location with respect to a reference point, for example, the indicated TRP, cell center), (xv) the uncertainty information for the determined WTRU location (e.g., expressed in terms of a range such as +2 meters) or quality information (e.g., indicating whether the indicated WTRU location is in the unit of 0.1 meter or 0.01 meter), (xvi) the indication of which method (e.g., RAT dependent positioning method such as DL-TDOA, DL-AOD, or AI/ML based positioning) is used to determine the WTRU location, and (xvii) the channel impulse response and associated DL-RS configurations used to determine CIRs.

In embodiments, the WTRU may receive a request to report assistance information (e.g., satellites that are in LOS, visible satellites, estimated atmospheric condition, Doppler shift, timing drift rate, phase drift rate).

In embodiments, the validity area may be associated with assistance information or configuration information. Examples of assistance information or configuration information associated with the validity area may be at least one or a combination of the following: (a) the PRS configuration to be used within the validity area, (b) the validity duration (e.g., how long the validity area is valid for, where validity duration may be expressed in terms of seconds, number of frames, slots, numbers), (c) the positioning method, e.g., a positioning method(s) that the WTRU shall use within the validity area, (d) the area information, e.g., information that indicates geographical location of the validity area which may be expressed in terms of geographical coordinates, or in term of configured geographical ID such as zone ID, Area ID or NTN cell ID, TN cell ID etc., (e) the periodicity at which the WTRU shall determine and/or report the determined location within the validity area, and (f) the fallback positioning method that the WTRU shall use when the WTRU is outside of the validity area.

In embodiments, the WTRU may receive configurations and/or information from the network more than one candidate validity areas where each validity area is associated with an index. In one example, the WTRU may receive candidate validity areas per satellite (e.g., mobile TRP, TRP) or a cell associated with a satellite from the network. The WTRU may determine the validity area out of the configured candidate validity areas and report the corresponding index to the network. The WTRU may determine to report more than one index, indicating that the validity area determined by the WTRU consists of more than one candidate of validity area. The candidate validity areas may be represented by geographical coordinates, terrestrial cell IDs and/or zone IDs. In another example, the WTRU may send a request to the network (e.g., via RRC, LPP message) for candidate validity areas.

If the network determines the validity area, the WTRU may be configured, by the network, with a validity area by receiving the index corresponding to the validity area.

In another example, the WTRU may receive assistance information associated with each candidate validity area. The assistance information may include atmospheric conditions (e.g., expected phase shift, expected time delay, timing drift rate, phase drift rate, expected pathloss) and associated validity conditions (e.g., time validity) for the assistance information, for example. One of the examples of validity conditions may be time validity which indicates the duration during which assistance information is valid. For example, the WTRU may determine that assistance information is not valid if at least one of the validity conditions is not satisfied (e.g., assistance information is expired).

In another example, the WTRU may send a request to the network for assistance information corresponding to the indicated validity area. The indicated validity area may be the validity area the WTRU prefers to be configured or determined validity area. The WTRU may indicate the validity area by corresponding index or by geographical information (e.g., geographical coordinates, cell IDs). As a response for the request from the WTRU, the WTRU may receive the validity area and associated assistance information from the network.

In another example, the WTRU may receive, from the network, candidate validity areas and associated assistance information via broadcast (e.g., SIB), groupcast or unicast periodically.

In embodiments, the WTRU may report the determined validity area to the network, based on a request by the network. The WTRU may include one or more of the following information in the report: (i) the determined validity area (e.g., cell IDs, zones, geographical area with coordinates), (ii) the WTRU location (e.g., cell ID), (iii) the WTRU capability, (iv) the accuracy requirement and cause (e.g., use case that defines the accuracy requirement), (v) the satellites from which to make measurements, and (vi) the determined LOS indicators with respect to satellites.

In embodiments, the WTRU may determine to report validity conditions (e.g., time validity) for the determined validity area. For example, the WTRU may indicate that the determined validity is valid for indicated duration (e.g., expressed in terms of hours, seconds, days).

In one example, the WTRU may determine to perform an associated positioning method (e.g., AIML-based positioning, RAT dependent positioning method such as DL-TDOA) if the WTRU determines that the WTRU is inside the validity area. The WTRU may determine whether the WTRU is inside the validity area based on a positioning method (e.g., RAT dependent positioning method, RAT independent positioning method such as GNSS) where the positioning method may be configured by the network. The WTRU may receive a request from the network to perform the configured positioning method within the associated validity area.

In embodiments, the WTRU may determine to send a request to the network if the WTRU is outside of the configured or determined validity area. The WTRU request may include one or both of a request for configuration of validity area, and a request for assistance information related to positioning (e.g., PRS configurations for TN or NTN based positioning, ephemeris).

In embodiments, the WTRU may determine to perform initial access when the WTRU determines that the WTRU is outside of the validity area.

In embodiments, the WTRU may determine to receive PRS from the network. The WTRU may receive a request to make measurements on the received PRS. The WTRU may further receive an indication as to which measurements the WTRU should make (e.g., RSTD, RSRP, RPRP per path, sample-based CIR, path-based CIR, sample-based PDP, path-based PDP).

In an example of updating validity area, the WTRU may determine to update the validity area and repot the updated validity area to the network. The update determination may be based on the determined positioning made after receiving the PRS from the network (e.g., NT or TNT). The WTRU may further determine the WTRU position based on a positioning method and measurements obtained from the received PRS. Based on information needed to determine the validity area (e.g., WTRU capability, WTRU location, atmospheric conditions), the WTRU may determine to update the validity area. If the validity area changes, the WTRU may determine to report, to the network, the updated validity area. The WTRU may receive configurations on periodicity for updating the validity area. For example, the WTRU may make measurements on the received PRS and the WTRU may determine its location and validity area at the configured periodicity. In another example, the WTRU may receive a time window during which the WTRU may determine its location and validity area at the configured periodicity.

The WTRU may also make a location determination based on AI/ML functionality. In embodiments, the WTRU may receive a request to report the applicability functionality to the network. An applicability functionality may be defined by one or more of the WTRU can perform AI/ML based positioning, the WTRU has AI/ML model(s) trained to perform AI/ML based positioning, and the WTRU having a functionality that can be activated or deactivated by the network.

The WTRU may also respond to the network indicating whether or the WTRU has the applicable functionality. An AI/ML functionality may be at least one or combination of several determinations or configurations.

In embodiments, an AI/ML functionality may define what a WTRU can do with the AI/ML functionality (e.g., AI/ML based positioning). The AI/ML functionality may indicate characteristics of input and/or output of an AI/ML model.

In embodiments, an AI/ML functionality may indicate type(s) of measurements the AI/ML model(s) can accept. In another example, an AI/ML functionality may indicate validity conditions for inference generated by the AI/ML model(s).

In embodiments, an AI/ML functionality may indicate a validity condition for the AI/ML model(s).

In embodiments, an AI/ML functionality may indicate type(s) of inference the AI/ML model(s) can generate (e.g., WTRU location, intermediate metric such as LOS indicator, measurement).

In embodiments, an AI/ML functionality may indicate capabilities of the AI/ML model(s) (e.g., latency required to generate inference, the number of inputs, memory size, computational complexity).

Other examples of AI/ML functionalities may be AI/ML based positioning. If the WTRU indicates the AI/ML based positioning as the supportable AI/ML functionality, it indicates that the WTRU may have an AI/ML model(s) which are capable of performing AI/ML based positioning.

In embodiments, the WTRU may indicate that the supportable AI/ML functionality is BW aggregation-based AI/ML-based positioning. This indicates that the WTRU has an AI/ML model that may accept measurements made based on BW aggregation. In a further example, the WTRU may indicate that supportable AI/ML functionality is PDP-based AI/ML based positioning. This may indicate that the AI/ML model the WTRU has can accept PDP as its input.

In embodiments, the WTRU may indicate the supportable AI/ML functionality is AI/ML based positioning with indicated maximum synchronization error. This indicates that the WTRU may have AI/ML model(s) that can tolerate timing error or network synchronization error up to the indicated maximum synchronization error.

In embodiments, there may be some permissible tolerance in the difference(s) in assistance information and/or PRS configuration(s) between training and inference. For example, assistance information used by the WTRU to train an AI/ML model may be different from assistance information the WTRU may receive when the WTRU is requested to generate inference based on the trained AI/ML model. For example, network synchronization error may be different by a few tenths of a micro-second between the training phase and inference phase and such difference may not affect inference performance. The WTRU may be preconfigured or configured with tolerance difference in assistance information between training and inference phase. If the difference is above the tolerable difference the WTRU may determine to use the fallback positioning method or report to the network that the WTRU cannot perform AI/ML based positioning due to the difference. In another example, PRS configurations and/or assistance information may be the same. For example, between training and inference phase, PRS configuration parameters such as Frequency Layer ID, TRP IDs or Cell IDs may need to be the same for the AI/ML model to be valid.

In another example, the WTRU may indicate that a supportable AI/ML functionality can accept N PDPs where each PDP is generated based on PRSs received from TRPs.

In embodiments, the WTRU may indicate that the supportable AI/ML functionality is area-based AI/ML-based positioning. This may indicate that the WTRU is able to perform positioning with an AI/ML model(s) that can generate inference (e.g., WTRU location) in the area associated with the AI/ML model(s).

In embodiments, the WTRU may indicate that the support for an AIM functionality with which INACTIVE mode base AI/ML based positioning can be achieved. The WTRU may also determine or otherwise identify an applicable AI/ML functionality based on WTRU condition, WTRU capabilities, NW condition, DL-RS configuration or assistance information given by the network.

An AI/ML functionality may be identified through reporting of the WTRU capabilities. The reported capabilities may be related to AI/ML capabilities (e.g., whether the WTRU is capable of supporting AI/ML based positioning), positioning capabilities (e.g., whether the WTRU is capable of supporting DL-TDOA, how many TRPs or PRSs the WTRU can measure) and/or communication capabilities (e.g., whether the WTRU is capable of supporting MIMO communication).

An AI/ML functionality may be identified through WTRU side conditions, NW side conditions and/or DL-RS configurations. For example, the WTRU may indicate that the WTRU has low battery power or hardware is overheating. Such condition may imply that the WTRU can only support low-complexity AI/ML functionality (e.g., making measurements from the serving cell only at large measurement periodicity).

A DL-RS configuration may identify an AI/ML functionality. For example, if the DL-RS configuration indicates frequency layer aggregation, it may imply that the WTRU needs to use AI/ML model(s) that can accept measurements made from aggregated frequency layers as AI/ML inputs.

NW side conditions may identify an AI/ML functionality. For example, if the NW assistance information indicates that there is a large synchronization error between TRPs or gNBs at the network may indicate that the WTRU shall use an AI/ML model(s) that is trained based on a similar condition (e.g., trained with data which is generated at the same or similar range of synchronization error).

An AI/ML functionality may be indicated by assistance information provided by the network (e.g., ID, flag or indicator). For example, the WTRU may receive the first ID associated with network side conditions and/or AIML functionality from the network during training phase. The WTRU may receive the second ID from the network during the inference phase. If the first and second ID are the same, the WTRU may determine that consistency in NW side conditions (e.g., conditions related to satellite hardware such as clock, amplifier) is preserved. In another example, the WTRU may send a request for the ID so that the WTRU can check consistency between training and inference phase.

In embodiments, the WTRU may determine an AI/ML functionality based on the content of a request sent by the network. For example, the network may send a request to perform positioning or AI/ML based positioning using an indicated set of measurements (e.g., PDP, timing, power, phase, angle measurements). The WTRU may receive a request to report measurements or WTRU location to the network. Based on the request about measurements and report content, the WTRU may determine an AI/ML functionality that can accept the requested measurements and yield the requested report content (e.g., WTRU location). The request may contain an explicit indication of which functionality to use (e.g., via functionality ID). In embodiments, the WTRU may determine an AI/ML functionality based on a configured positioning method. For example, the WTRU may be configured with a timing-based positioning method (e.g., DL-TDOA) and the WTRU may receive, from the network, an indication to use an AI/ML model to determine the WTRU location. Based on the configured positioning method and assistance information, the WTRU may determine the AI/ML functionality, e.g., which AI/ML model(s) to use for positioning. In embodiments, the WTRU may receive a configuration for an AI/ML based positioning method and based on the configured positioning method, the WTRU may determine the AI/ML functionality.

In embodiments, the WTRU may utilize certain enablers of an AI/ML functionality. For example, whether the WTRU can use the AI/ML functionality may depend on WTRU conditions, PRS configurations and/or NW conditions. If WTRU conditions change dynamically, the WTRU may need to send an update to the network about supportable AI/ML functionalities.

In embodiments, the WTRU may receive, from the network, a request for positioning. The WTRU may receive configurations related to a positioning method (e.g., RAT dependent positioning method, AI/ML based positioning method) to be used by the WTRU. The WTRU may receive the configuration for a positioning method based on the applicable functionality reported to the network.

In embodiments, the WTRU may report the location estimate obtained from the configured positioning method. The WTRU may further receive a request from the network to report at least one of the following: (a) an uncertainty associated with AI/ML positioning output, (b) whether consistency was preserved between training phase and inference phase for AI/ML based positioning, and (c) environmental conditions (e.g., temporal, power or phase distortion caused by environments or Doppler such as time shift or time drift rate due to Doppler, phase shift or drift rate due to Doppler, phase shift caused by atmosphere, time shift caused by atmosphere) where Doppler may be caused by moving TRP (e.g., satellite) or WTRU movement.

In embodiments, there may be required a determination of consistency within the measurements. For example, the WTRU obtains WTRU location from AI/ML model(s) by using measurements as input for the AI/ML model(s). Conditions under which the AI/ML model(s) are trained should be realized during the inference phase when the AI/ML model(s) are used to generate inference (e.g., WTRU location). Otherwise, inference will be inconsistent and the WTRU may not be able to obtain accurate position(s). Therefore, it is important for the WTRU or network to determine whether the conditions are consistent. An example of the conditions is the area (validity area) in which the AI/ML models are trained.

In embodiments, the WTRU may determine whether consistency in the validity area is preserved between training and inference phase by checking the validity area during the training phase and inference phase. For example, if the validity area is the same between training phase and inference phase, the WTRU may determine that condition was consistent and trained AI/ML model(s) can be used to generate inference (e.g., WTRU location).

In embodiments, the WTRU may report validity area during training phase and inference phase. For example, before the WTRU may receive PRS configurations, the WTRU may report the determined validity area (e.g., first validity area). When the WTRU reports applicability functionality, the WTRU may report on the determined validity area (e.g., second validity area). If the first and second validity area is the same, the WTRU may determine that consistency is preserved. The WTRU may send a request to the network whether consistency is preserved based on the reported validity area. As the response for the request, the WTRU may receive feedback from the network, indicating whether consistency is preserved based on reported first and second validity area.

In embodiments, the WTRU may receive a request to report whether consistency in the validity area is preserved between training and inference phase. Still further, the WTRU may also report to the network if consistency in the validity area is not preserved (e.g., the WTRU moves outside of the validity area during the inference phase).

In embodiments the WTRU may report the measurements and/or determined validity area to the network. As the response for reported validity area and/or measurements, the WTRU may receive, from the network, an ID, flag or indicator. For example, the WTRU may report the first validity area and receive an ID (e.g., first ID) from the network. The WTRU may report the second validity area to the network and receive an ID (e.g., second ID) from the network. If the first and second ID are the same, the WTRU may determine that consistency is preserved. In embodiments, the WTRU may send a request for the ID so that the WTRU can check consistency between training and inference phase.

Initial access triggering conditions may also be utilized. In one example, the WTRU may determine its position based on the configured, fallback or default positioning method (e.g., GNSS, AI/ML based positioning, RAT dependent positioning method, RAT independent positioning method). After determining its position, the WTRU may determine to perform initial access (e.g., send PRACH to the network) if at least one of the following conditions is satisfied: (i) the WTRU determines validity area and the WTRU is outside of the validity area, (ii) the WTRU determines validity area and the WTRU is inside of the validity area, (iii) the trigger condition for positioning (e.g., emergency call), (iv) and uncertainty associated with AI/ML positioning output, (v) consistency not being preserved between training and inference for AI/ML based positioning, and (vi) the number of satellites for positioning is below configured threshold.

In embodiments of a low latency use case, the WTRU may receive a request for applicability functionality based on the cause for positioning the WTRU reports. For example, if the WTRU sends a request for positioning due to a need to make an emergency call, the WTRU may receive a request to report at least one of the following from the WTRU: (a) the applicability functionality, (b) the WTRU location (e.g., cell ID, location coordinate) and required granularity (e.g., cell level, meter or centime level), and (c) the WTRU capability. The WTRU may also determine to report requested information to the network.

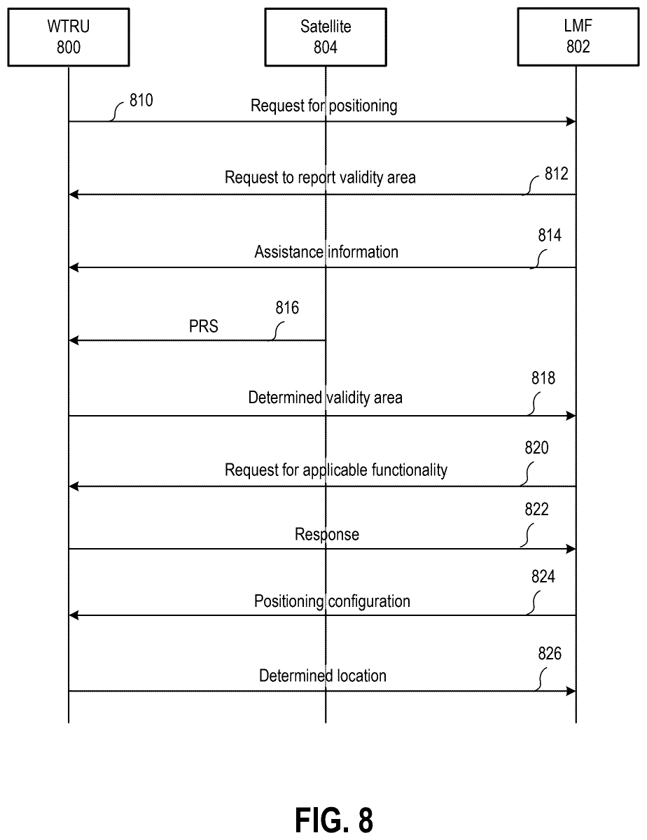

An embodiment of a signaling exchange between a WTRU 800 and an LMF 802 is shown in FIG. 8. As indicated, the WTRU 800 send a request 810 for positioning to the LMF 802. Also, the network 802 may also send 812 a request to the WTRU 800 to report a validity area. The WTRU 800 may further receive assistance information 814 from the LMF 802. The WTRU 800 may receive PRS 816 from TRPs (e.g., a satellite 804). Based on assistance information and/or other measurements, the WTRU 800 may determine the validity area and then report 818 the validity area to the network 802. The WTRU 800 may further receive a request 820 for applicability functionality from the network 802. The WTRU 800 response to request 820 is a report 822 of the applicable functionality. The WTRU 800 may further receive configurations for positioning 824 (e.g., positioning method the WTRU 800 shall use). Based on the configuration, the WTRU 800 may determine its location and report 826 the location to the network 802.

In embodiments, wherein a Mobile Terminated Location Request (MT-LR) is present, the WTRU may receive a request from the network. The WTRU may receive a request for positioning and accuracy requirements. The WTRU may then receive first assistance information. The WTRU may report the determined validity area. The WTRU then receives PRS configuration and second assistance information. The WTRU may receive a request to report applicable functionality and respond with the requested report. Thereafter, the WTRU may receive third assistance information.

In a still further embodiment, assuming, e.g., a Mobile Originated Location Request (MO-LR) is present, the process may proceed with the WTRU determining the positioning accuracy requirement based on a triggering condition (e.g., the need for timing compensation for NTN, emergency call, acquiring WTRU location for NW verification). The WTRU sends a request for PRS configuration and assistance information for WTRU-based positioning. The WTRU receives, from the network, first assistance information (e.g., atmospheric condition, ephemeris) and a request from the network to report validity area for AI/ML positioning. The WTRU determines the validity area for AI/ML positioning based on at least one or more of the following: (a) the WTRU location, for example, terrestrial cell ID (if the WTRU cannot determine its location based on cell information, the WTRU sends a request for PRS configuration via a satellite link), (b) environmental conditions (e.g., atmospheric conditions), (c) positioning accuracy requirement, and (d) LOS condition with satellite(s). The WTRU reports the determined validity area to the network and optionally reports at least one or both of the following: (i) the Satellites used to determine the validity area, and (ii) the WTRU location, accuracy requirement and determined LOS conditions for the satellites.

In embodiments, e.g., the MO-LR related process discussed above, the following additional steps may be performed.: The WTRU may receive PRS configurations and second assistance information (e.g., information needed to receive PRS). The WTRU may receive a request to report applicability functionality, for example an AI/ML based positioning (e.g., whether AI/ML models are trained and ready for inference). The WTRU reports the applicability functionality. Further, and the WTRU receives third assistance information (e.g., information needed to perform RAT dependent positioning, inference generation), with the third assistance information, for example, being the PRS configuration for the fallback positioning method or (optionally) PRS configuration generating inference for AI/ML based positioning.

In the various embodiments discussed herein, the operation of the WTRU) is preferably defined by a processor configured to perform the various steps or method. Generally, the WTRU may first determine a positioning accuracy requirement based on one or more triggering conditions. The WTRU may send a request for a positioning reference signal (PRS) configuration and receives one or more PRS transmissions. The WTRU may then receive a request from the network to report a validity area, such as for AI/ML positioning. The validity area is contemplated to be associated with a non-terrestrial network (NTN). The determination by the WTRU of the validity area for AI/ML positioning may be based on the positioning accuracy requirement in one or more PRS transmissions. The WTRU may then report to the network, preferably indicating at least the validity area for AI/ML positioning.

In embodiments, the positioning accuracy requirement may include a range of accuracy of the WTRU. Further, the triggering condition may include one or more of a need for timing compensation for an NTN, an emergency call, and a network verification request. It should be noted that the network requesting the validity area may be a non-terrestrial based network. In embodiments, the WTRU report may include an indication of one or more satellites used by the WTRU to determine the validity area, a location of the WTRU, the positioning accuracy requirement, or a line of sight (LOS) condition with one or more satellites.

In embodiments, the WTRU may request assistance information for WTRU-based positioning. For example, the processor may be configured to receive the assistance information from another network. In addition, the assistance information may include one or both of an indication of an atmospheric condition or an ephemeris. The WTRU processor may further be configured to determine the validity area for AI/ML positioning based on a location of the WTRU, for example, wherein the location is based on a terrestrial cell identifier (ID). The WTRU processor may be further configured to determine the validity area for AI/ML positioning based on an environmental condition, such as an atmospheric condition. In addition, or as an alternative, the determination of the validity area for AI/ML positioning may be based on a line-of-sight (LOS) condition associated with one or more satellites. In embodiments, the WTRU may be configured to request a PRS configuration that indicates the position accuracy requirement set within the WTRU or received as part of a triggering event. In embodiments, the request for PRS configurations may indicate a position accuracy requirement for the WTRU. In embodiments, the one or more PRS configurations contains coverage information for the PRS, including the number of states the PRS beam is covering.

1. A wireless transmit/receive unit (WTRU) comprising:
a processor configured to:
determine a positioning accuracy requirement based on a triggering condition;
send a request for a positioning reference signal (PRS) configuration;
receive PRS configuration;
receive a request from the network to report a validity area for artificial intelligence or machine learning (AI/ML) positioning, wherein the validity area is associated with a non-terrestrial network;
determine the validity area for AI/ML positioning based on the positioning accuracy requirement and the PRS configuration; and
send a report to the network, wherein the report comprises an indication of the validity area for AI/ML positioning.

2. The WTRU of claim 1, wherein the positioning accuracy requirement indicates a range of accuracy of the WTRU.

3. The WTRU of claim 1, wherein the triggering condition comprises a need for timing compensation for a non-terrestrial network, an emergency call, a network verification request.

4. The WTRU of claim 1, wherein the network comprises a non-terrestrial based network.

5. The WTRU of claim 1, wherein the report comprises an indication of one or more satellites used by the WTRU to determine the validity area, a location of the WTRU, the positioning accuracy requirement, or a LOS condition with the satellites.

6. The WTRU of claim 1, wherein the request further indicates a request for assistance information for WTRU-based positioning, and wherein the processor is configured to receive the assistance information from the network, the assistance information comprising an indication of an atmospheric condition or an ephemeris.

7. The WTRU of claim 1, wherein the processor is configured to determine the validity area for AI/ML positioning based on a location of the WTRU, wherein the location of the WTRU is based on a terrestrial cell ID.

8. The WTRU of claim 1, wherein the processor is configured to determine the validity area for AI/ML positioning based on an environmental condition (e.g., atmospheric condition).

9. The WTRU of claim 1, wherein the processor is configured to determine the validity area for AI/ML positioning based on a line-of-sight (LOS) condition associated with one or more satellites.

10. The WTRU of claim 1, wherein the request for PRS configuration indicates the position accuracy requirement of the WTRU.

11. A method performed by a wireless transmit/receive unit (WTRU), the method comprising:
determining a positioning accuracy requirement based on a triggering condition;
sending a request for a positioning reference signal (PRS) configuration;
receiving a PRS configuration;
receiving a request from the network to report a validity area for artificial intelligence or machine learning (AI/ML) positioning, wherein the validity area is associated with a non-terrestrial network;
determining the validity area for AI/ML positioning based on the positioning accuracy requirement and the PRS configuration; and
sending a report to the network, wherein the report comprises an indication of the validity area for AI/ML positioning.

12. The method of claim 11, wherein the positioning accuracy requirement indicates a range of accuracy of the WTRU.

13. The method of claim 11, wherein the triggering condition comprises a need for timing compensation for a non-terrestrial network, an emergency call, a network verification request.

14. The method of claim 11, wherein the network comprises a non-terrestrial based network.

15. The method of claim 11, wherein the report comprises an indication of one or more satellites used by the WTRU for determining the validity area, a location of the WTRU, the positioning accuracy requirement, or a LOS condition with the satellites.

16. The method of claim 11, wherein the request indicates a request for assistance information for WTRU-based positioning, and the method further comprising receiving the assistance information from the network, the assistance information comprises an indication of an atmospheric condition or an ephemeris.

17. The method of claim 11, wherein determining the validity area for AI/ML positioning is based on a location of the WTRU, and wherein the location of the WTRU is based on a terrestrial cell ID.

18. The method of claim 11, wherein determining the validity area for AI/ML positioning is based on an environmental condition (e.g., atmospheric condition).

19. The method of claim 11, wherein determining the validity area for AI/ML positioning is based on a line-of-sight (LOS) condition associated with one or more satellites.

20. The method of claim 11, wherein the request for PRS configuration indicates the position accuracy requirement of the WTRU.
